(19) United States
(12) Patent Application Publication
(10) Pub. No.: US 2016/0052231 A1
(43) Pub. Date: Feb. 25, 2016

(54) DOUBLE-LATCH CLOSING SYSTEM FOR AERONAUTICAL EQUIPMENT, SUCH AS TROLLEYS HAVING ULTRALIGHT COMPOSITE PANELS

(71) Applicant: IACOBUCCI HF AEROSPACE S.P.A., Ferentino, FR (IT)

(72) Inventor: Lucio IACOBUCCI, Ferentino (IT)

(21) Appl. No.: 14/778,973

(22) PCT Filed: Apr. 9, 2014
(86) PCT No.: PCT/IT2014/000107

§ 371 Date: Sep. 21, 2015

(30) Foreign Application Priority Data
Apr. 9, 2013 (IT) RM2013A000211

(51) Int. Cl. B32B 5/24; E05C 1/14; A47B 31/00; A47B 47/00; B62B 3/00; B32B 5/02; B32B 5/08; B32B 5/12; B32B 3/12; E05C 1/00; A47B 47/04

(52) U.S. Cl. CPC B32B 5/245; E05C 1/006; E05C 1/145; A47B 31/00; A47B 47/0066; A47B 47/04; B32B 5/024; B32B 5/08; B32B 5/12; B32B 3/12; B62B 3/003; B32B 2260/023; B32B 2262/0269; B32B 2262/101; B32B 2266/08; B32B 2307/304; B32B 2307/558; B32B 2307/54; B32B 2307/3065; B32B 2307/738

(57) ABSTRACT

The present invention relates a double-latch closing system which may be advantageously applied to aeronautical devices such as trolleys, ovens, waste compactors, galley inserts and standard units. It comprises a pair of tongues (33, 37), each operationally connected to a handle (16a, 17a). One handle (17a) is provided with a locking and safety means (17′a) which acts on the other handle (16a). Particularly preferred is the use of said closing system for aviation trolleys made with ultralight composite panels having superior mechanical properties as regards aeronautical standards. The panels may be advantageously used to construct food and beverage trolleys to be used in the aviation sector.

### FIELD OF THE INVENTION

The present invention relates to a closing device for aeronautical equipment, such as food and beverage trolleys, made with ultralight composite panels.

The present invention also relates to an ultralight composite panel which has optimum mechanical properties with regard to aeronautical requirements. The panel may be advantageously used to construct ultralight food and beverage trolleys, in particular for the aviation sector.

The invention also relates to a trolley having a door or doors with a safety closing system.

### PRIOR ART

In view of the particularly strict safety standards in the aviation sector with regard to the closing systems fitted to panels, doors and shutters, the present invention aims to solve the problems associated with the operations of opening and closing trolleys, galley inserts, standard units and other similar aeronautical components.

Furthermore the aviation sector is also characterized by very stringent technical and weight-related requirements with regard to the materials to be used in this sector. A high mechanical strength and impact resistance, low toxicity and low inflammability are some of the characteristics which are required, although these are properties associated with materials which have a high specific weight, such as metals. The use of materials with a high specific weight in the aviation sector, however, reduces the load capacity of the aircraft and is therefore one of the most important variables to be taken into consideration when choosing materials for the construction of components of parts and devices for aeronautical use.

Foam materials, such as those based on polypropylene, polyethylene, polycarbonate and polyvinyl chloride resins, are very light and capable of absorbing a large amount of impact energy, but are inflammable and are also unsuitable in terms of heat release, fume and CO emissions.

Manufactured articles, for which the use of materials with a sufficient mechanical strength and impact resistance is required, but which at the same time must have a low inflammability and low fume and gas emissions, are trolleys for use in the aviation sector, such as those used for the distribution of food and beverages.

The present average weight of trolleys for aeronautical use is around 22 kg for a full-size trolley, i.e. with a maximum length of 810 mm; the target weight which the invention aims to achieve for this category of products is one below 16 kg while maintaining or improving the mechanical properties of the trolleys conventionally used. The fundamental idea—the result of a series of analyses carried out on weights and materials—is that of managing to replace the basic metal which characterizes these products (aluminium) with composite materials which have a lower density and comparable, if not superior, mechanical properties. In particular, the idea which has occurred is that of replacing the side panels of trolleys, which constitute about 30% of the overall weight of the trolley, while leaving unchanged the conventional support structure, front and rear doors, base and top.

The present composition of the side panels is as follows:
layer with guides for sliding of the drawers: aluminium of 0.7 mm thickness (weight of about 1.7 kg)
inner insulating layer: polyester or equivalent polymer foam with a density of 60 kg/m³ (weight of about 0.4 kg)
outer layer (panel decoration): aluminium of 0.6 mm thickness, usually powder-coated (weight of about 1.2 kg) giving a total weight of about 3.3 kg.

The present invention proposes a combination of materials which solve the problems mentioned above and allow the manufacture of articles suitable for use in the aviation sector since they comply with the strict standards in this area of use.

### SUMMARY OF THE INVENTION

A double-latch closing system has now been realized and forms the subject of the present invention, said system comprising namely two closing devices, of the so-called latch type, which are independent of each other and which may be used in all such equipment which requires a safety closing system, such as: trolleys, ovens, galley inserts, waste compactors, folding trolleys and standard units for aeronautical use. The resultant closing system is a multi-point closing system which allows closing of the leaf or door by means of a manual slamming action.

Another object of the present invention is to provide multilayer panels which are both light and have optimum mechanical properties and which may be combined together so as to allow the manufacture of ultralight and ultra-strong products which can be used in sectors which require both these characteristics, for example the aviation sector.

The panels according to the invention consist of the combination of a first laminate which may be multi-layer, or outer laminate, and a third laminate which may be multi-layer, or inner laminate, comprising a composite, which may be in the form of a fabric made with glass fibres and kevlar fibres interwoven at 45° or 90°, so as to form a kind of kevlar/glass-fibre layer, a PEI (polyetherimide) or similar polymer resin being present between said fabric fibres so as to impregnate the two types of fibres; also suitable are thermosetting resins, such as epoxy and phenolic resins. The kevlar fibre sheet or composite may be advantageously replaced by a sheet of glass fibres interwoven at 45° or 90°, also so as to form a kind of fabric, which is also impregnated with PEI or a similar polymer. An intermediate layer is arranged between said first and third layers or laminates, said intermediate layer comprising a closed-cell expanded polymer, for example foam with a density of 40 kg/m³ or honeycomb with a density of up to 30 kg/m³ or also other low-density polymer foams, or a honeycomb layer, such as Nomex.

Another object of the invention consists in providing the third layer with pressed parts obtained by means of thermoforming, these pressed parts being for example in the form of guides. These guides are intended to allow the sliding of drawers, shelves, trays and the like.

A further object of the invention is to provide a trolley, the side panels of which are formed by the panels of the invention. The panels may in any case be used to construct also the other parts of the trolley, such as the front and rear doors, the top and bottom.

Yet another object of the invention is to provide a trolley of the lightweight type made with multi-layer panels which has a safety closing system consisting of the combination of two closing devices, of the so-called latch type, which are independent of each other and must be activated simultaneously in order to allow opening of the door. The combination of the parts is such as to prevent random or unintentional opening of the trolley door. The latches are positioned on one or both the front and rear doors of the trolley.

Further objects will become clear from the detailed description of the invention below, with reference to preferred embodiments, it being understood however that variations are possible without thereby departing from the scope of protection defined by the accompanying claims and with reference to the figures of the accompanying drawings.

### BRIEF DESCRIPTION OF THE FIGURES

FIG. 1A is an exploded view from above of a first embodiment of the closing device according to the invention;

FIG. 1B is an exploded view from above of a second embodiment of the closing device according to the invention;

FIG. 2A is an exploded view, from below, of the closing device shown in FIG. 1A;

FIG. 2B is an exploded view, from below, of the closing device shown in FIG. 1B;

FIG. 3A is a schematic perspective view of the detail of the door in which the closing device shown in FIGS. 1A and 2A is fitted;

FIG. 3B is a schematic perspective view of the detail of the door in which the closing device shown in FIGS. 1B and 2B is fitted;

FIG. 4 is a schematic perspective view of the position of the lock strikers mounted on the vertical profile of the trolley panel;

FIG. 5 is a schematic perspective view of a detail of the striker shown in FIG. 4;

FIG. 6 is an exploded view from above of another embodiment of the closing device according to the invention shown in the detail 8A of FIG. 8 below;

FIG. 7 is an exploded view, from below, of the closing device, shown in the detail 8A of FIG. 8 below;

FIG. 8 is a schematic perspective view of an aircraft trolley according to the invention to which the panels according to the invention may be fitted; the detail 8A shows in schematic form the two-latch opening system as a whole;

FIG. 9 is a schematic front view of the trolley according to FIG. 8;

FIG. 10 is a schematic side view of the trolley according to FIG. 8;

FIG. 11 is a schematic perspective view of a panel according to the invention formed by three layers or laminates;

FIG. 12 is a schematic cross-sectional view of a pressed profile of the inner layer or laminate of the panel according to the invention;

FIG. 13 is a schematic perspective view of a hot-forming device for forming the pressed parts on the inner layer of the panel according to the invention.

### DETAILED DESCRIPTION OF THE INVENTION

The invention relates to a double-latch or twin-action closing system for closing a shutter, such as a door or leaf or flap on a corresponding frame or upright or portions thereof, said closing system being housed inside a box-like element and comprising a pair of tongues or levers, or other closing system of the latch type, i.e. a mechanical spring closing system.

The two tongues are operationally connected to respective handles, each of which acts on the corresponding tongue so as to release or engage it from/with the corresponding lock striker. As a safety measure to prevent any random or unintentional opening, one of the two handles is provided with locking and safety means such that operation of the handle causes operation also, during the opening movement, of the other handle and correspondingly releases both the tongues, while operation of only the handle without these locking and safety means does not allow opening of the shutter since it frees only one tongue.

Advantageously the locking and safety means may be realized in the form of a lug fixed to one of the two handles and projecting towards the other handle.

The closing system according to the invention is particularly suitable for use in aviation trolleys made preferably using the ultralight panels according to the present invention. The panels according to the invention may be used as side walls of said trolleys, but may also form the front and rear doors, the top panel, as well, if need be, the bottom and rear panels for the half-size trolley. The same solution may also be used on shorter food and beverage trolleys, with a length of more than 405 mm, and also on other galley inserts (waste compactors, ovens, folding trolleys, standard units, etc.).

Moreover, owing to the aforementioned characteristics, said panels may be also used in other sectors such as the automobile, tramway and naval sectors, for all the devices and the means used in said technical fields.

There is a particularly pressing need to provide for the aviation market a panel-type food and beverage trolley which is ultralight and extremely strong and which is also provided with a safety closing device which meets the current safety standards.

The present average weight of the trolleys is in the region of 22 kg for a full-size trolley and the target weight which has been proposed for this category of product is one of below 16 kg. As regards half-size trolleys, the present average weight is around 16 kg and the proposed target weight is one of below 10 kg.

The fundamental idea—the result of a series of analyses carried out on weights and materials—is that of managing to replace the basic metal which characterizes these products (aluminium) with composite materials which have a lower density and mechanical properties which are comparable if not superior to those of aluminium. Most of the work has been carried out on side panels, which represent about 30% of the overall weight of the trolley.

The outer layer of conventional trolleys, which is usually made of aluminium, has been replaced with at least one laminate sheet of composite material consisting preferably of the thermoplastic resin PEI (polyetherimide) or other polymer with similar characteristics, reinforced with glass and kevlar fibres interwoven at an angle of between 45° and 90°, typically at 45° or 90°; also suitable are thermosetting resins such as epoxy or phenolic resins. Similarly the aluminium of the inner layer has been replaced with at least one laminate sheet of composite material consisting preferably of the thermoplastic resin PEI (polyetherimide) or other similar polymer reinforced with glass fibres interwoven at an angle of between 45° and 90°, typically at 45° or 90°.

For a total thickness of the laminate (inner, pressed, side of the trolley) equal to 0.3 mm (compared to 0.7 mm for aluminium), there is a volumetric density of about 1.9 kg/m³, resulting in a saving, respectively, of about 1.2 kg per panel, for the full-size trolley, and 0.6 kg for the half-size trolley, producing a weight of inner laminate equal to about 0.5 kg for the full-size trolley and 0.25 kg for the half-size trolley.

The sheet of kevlar may be advantageously replaced by a sheet of glass fibres interwoven at an angle of between 45° or 90°, typically at 45° or 90° relative to each other, so that they also form a kind of fabric. An intermediate layer is arranged between said first and third layers (inner and outer laminates), said intermediate layer having a density of less than 40 kg/m³, typically an expanded polymer with a closed-cell or honeycomb structure, for example polyethylene foam with a density of 40 kg/m³ or honeycomb with a density of 30 kg/m³ or more.

The kevlar, inserted on the inner side (which may be painted) of the laminate, increases the impact resistance of the panel. The glass fibres provide the entire laminate with a significant rigidity greater than that of aluminium and with a total thickness of only 0.4 mm (differently from the 0.6 mm of aluminium), but with a density of about 1.9 kg/m³ as opposed to the 2.7 kg/m³ of aluminium, with a weight saving of about 0.7 kg per single panel. Moreover, the advantage of this type of material lies in the possibility of obtaining a laminate which is already painted in a colour from the scale white to black, with savings as regards the cost and increased weight offered, normally, by a powder or liquid coating.

Basically, each panel according to the invention may be made with an outer layer or laminate and an inner layer or laminate consisting of the composite kevlar/PEI/glass-fibre or kevlar/thermosetting resin/fibres or the composite glass-fibre/PEI/glass-fibre or kevlar/thermosetting resin/fibre or glass-fibre prepreg/PEI or glass-fibre prepreg/thermosetting resin, the intermediate layer consisting of a closed-cell expanded polymer, such as PVC/PET.

The intermediate expanded polymer layer may be advantageously replaced by a layer of material with a honeycomb structure, such as Nomex. The intermediate layer may also be reinforced with reinforcing systems such as extruded aluminium profiles or materials which are in any case light with the same or superior mechanical properties.

Particularly preferred is a panel comprising: at least one sheet consisting of the composite kevlar/PEI/glass-fibre; expanded polymer with a closed-cell or honeycomb structure; at least one sheet consisting of the composite glass-fibre/PEI/glass-fibre or glass-fibre prepreg/PEI bonded together.

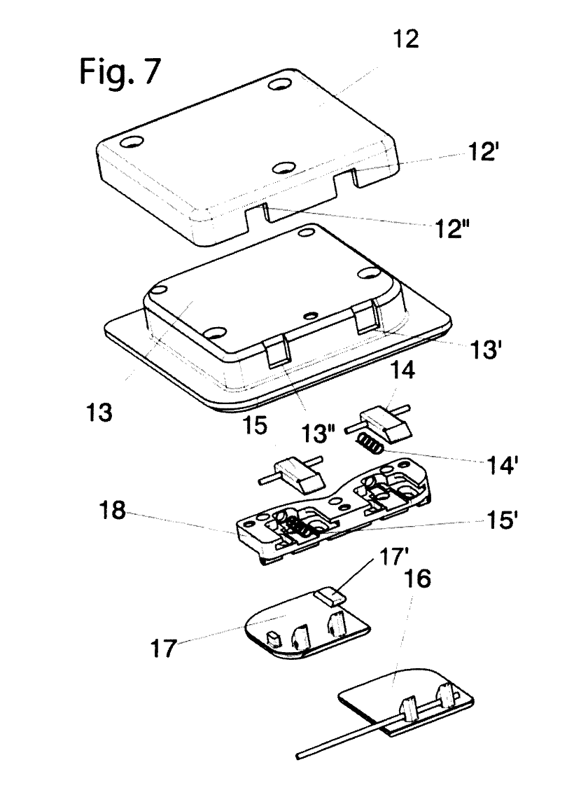

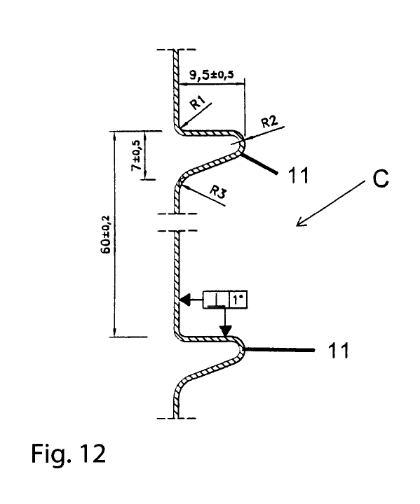

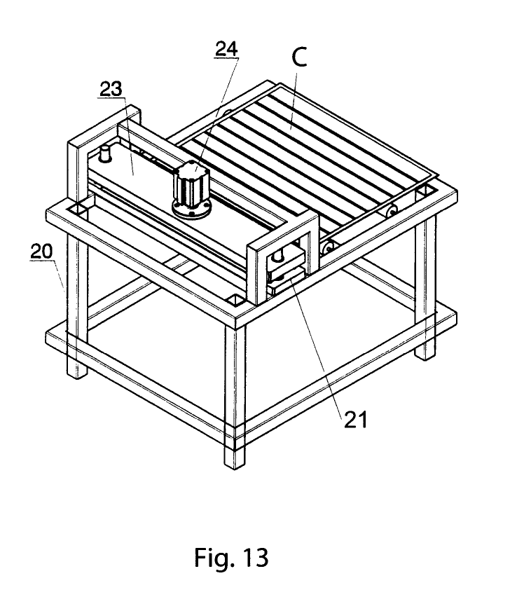

The most difficult goal achieved was that of providing in the inner layer of the panel a series of pressed parts, similar to those normally formed in aluminium, in order to allow the sliding of drawers, shelves and trays, typically formed by means of a cold press. In the present case, cold-pressing could not be performed using a thermoplastic material and therefore an ad hoc thermoforming device for performing hot-pressing was designed. The prototype apparatus is shown in FIG. 7 and comprises a platform for arrangement of the laminate which, once suitably positioned, is made to pass under a series of ceramic lamps heated to a high temperature (about 300° C.) until the melting point of the material is reached. After being arranged in position for a certain time (20 to 30 seconds), the laminate is transferred underneath a male/female mould which presses against the sheet in order to thermoform the material so as to obtain the pressed guides. The cross-section of the panel guides was optimized in order to avoid wrinkling defects and cracking during the said forming process. A non-limiting example of a profile is shown in cross-section in FIG. 12, where R1, R2 and R3 have respectively the following value: R1=1±0.3 mm, R2=2±0.3 mm R3=3±0.3 mm. The device in FIG. 7 is optimized in order to be able to stamp, using also the same platform, also two half-size trolleys, simply replacing the die and punch envisaged for the full-size trolley.

Overall the weight saving which it has been possible to achieve with this new panel configuration is about 2 kg per panel and namely, 4 kg for the entire full-size trolley and about 2.5 kg for the entire half-size trolley, merely by means of replacement of the side panels. In the case of half-size panels preferably the rear panel is also replaced.

The panels according to the invention have a flexural and shearing breakage strength comparable or superior to those of aluminium panels of the same thickness and size. Moreover the panels which have undergone press-forming have mechanical characteristics which are even superior. Moreover, the panels according to the invention have greater insulating and thermal properties, improving the thermal capacity of the trolley.

The use of PEI provides the following further advantages: it consolidates bonding of the fibres, resulting in an increased structural strength and impact resistance, as well as easier washability of the panels, and has an excellent cost/performance ratio.

Therefore the combination of the materials which form the panels according to the invention gives rise to the unexpected combination of properties: lightness, mechanical strength, impact resistance, thermal resistance and heat barrier, low toxic gas and fume emissions, such as to fall well within the necessary values laid down by the strict aviation standards. The panels are self-extinguishing and flame-retarding, producing a small amount of fumes and made with non-toxic materials.

### Description of a Preferred Embodiment of the Invention

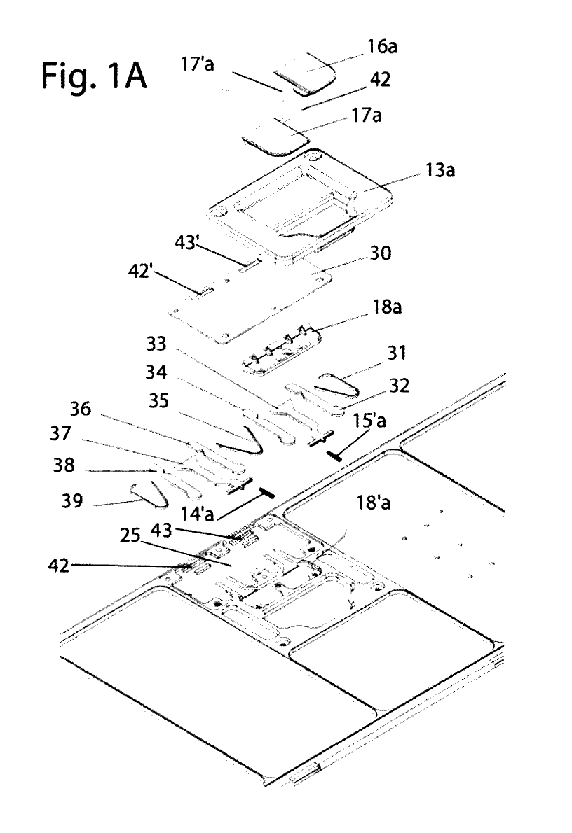

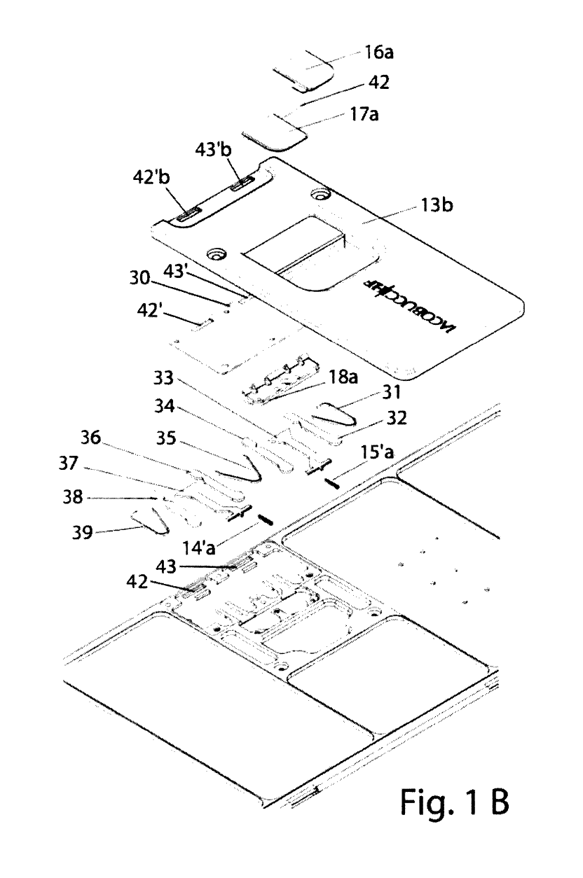

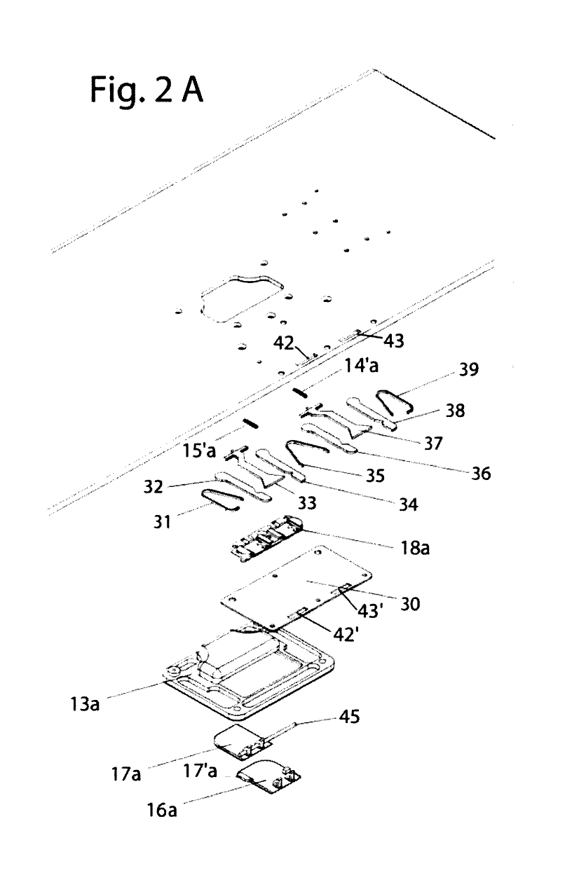

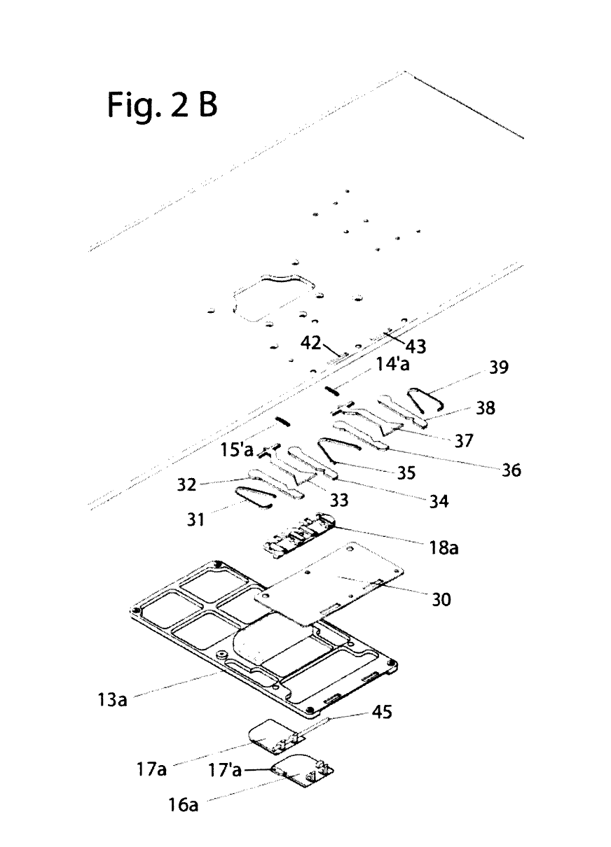

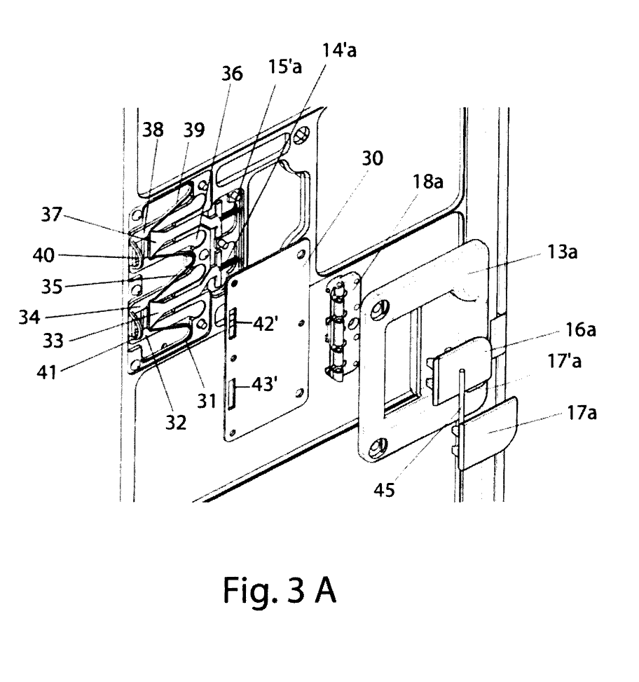

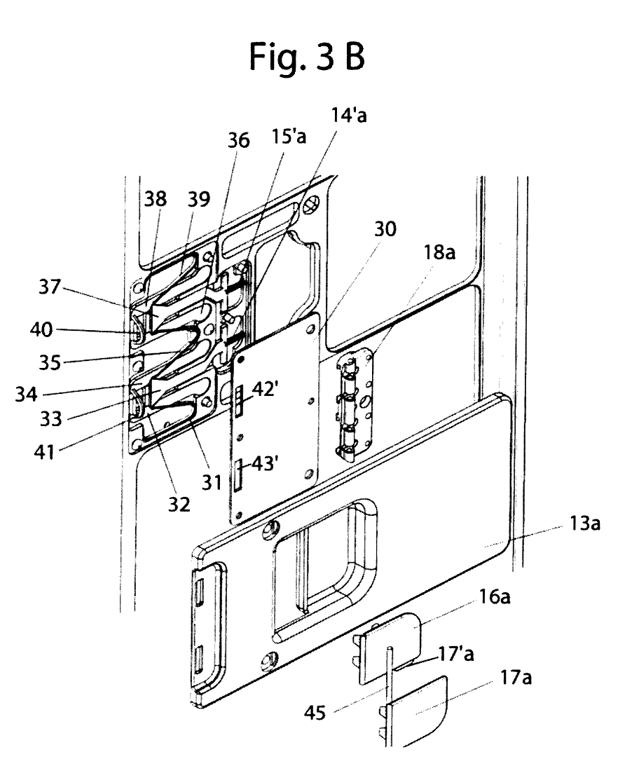

With reference to the accompanying FIGS. 1 to 7, preferred embodiments of the closing system according to the invention are shown.

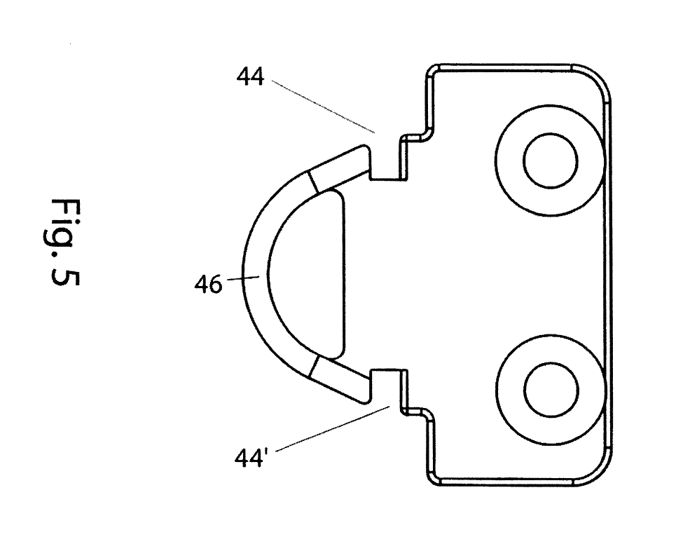

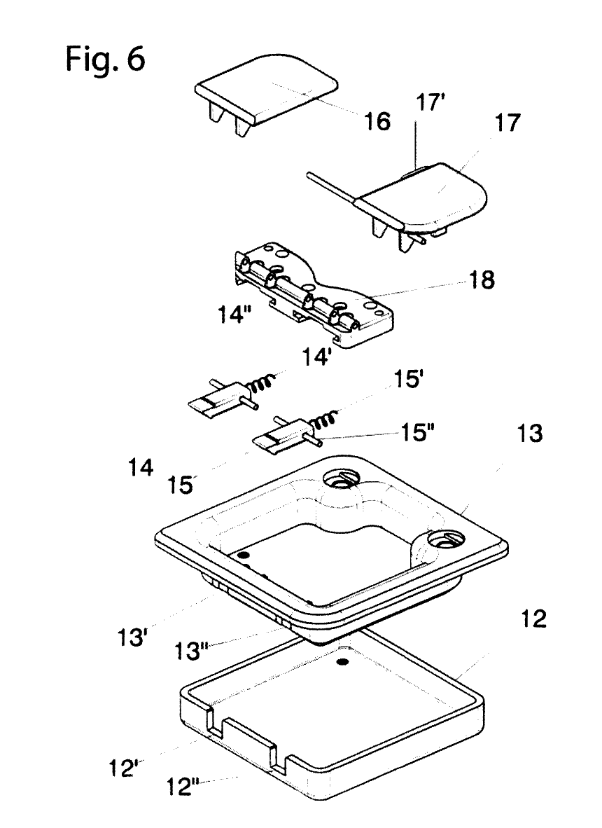

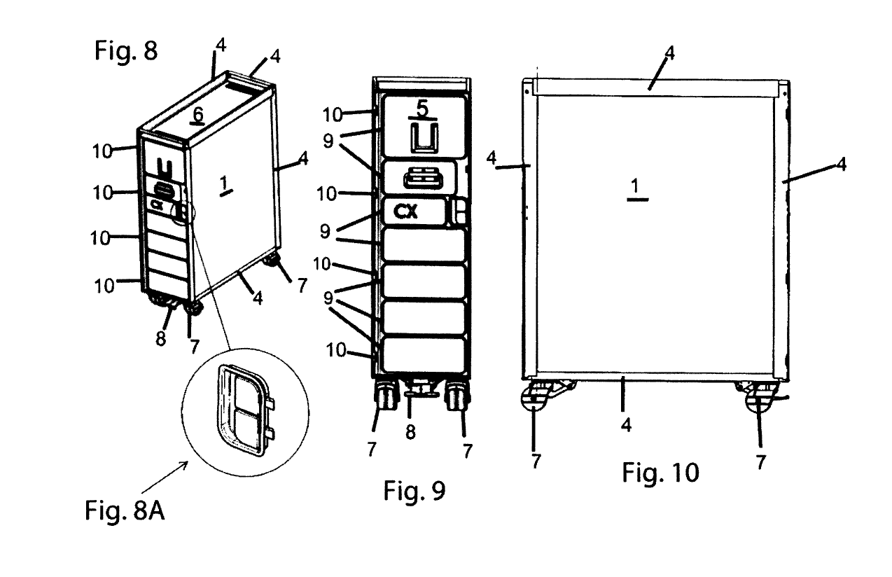

With particular reference to FIGS. 6 and 7 these show an exploded view of the spring-action closing/opening device, i.e. latch, which is shown in its entirety in the detail 8A of FIG. 8. The exploded views in FIGS. 6 and 7 show, respectively, from top to bottom, the individual components of the double-latch closing/opening device. The housing for the double latch device consists of a double female and male box-like element, 12, 13, respectively, with a thickness such that it may be seated inside the recess of the panel of the door onto which it is to be fitted. The said double boxlike elements 12-13 are respectively provided with openings 12′-12″ and 13′-13″ corresponding to each other and allowing the entry/exit of the tongues 14-15 for closing/opening the door. The tongues 14-15 are operationally connected to two handles 16-17, respectively, by means of springs 14′-15′ and pins 14″-15″, the whole assembly being connected to a lock support piece 18 which is suitably shaped to receive said tongues, springs and pins and be both closed by the end wall of the male box-like element 13 and hinged on the handles 16-17. Of the two handles, the handle 17 is further provided with a lug 17′ which allows operation of both levers by merely operating the handle 17.

Functioning of the double latch closing device is now described. In order to open the door both handles must be operated by means of simultaneous raising outwards of the handles 16 and 17 or of the handle 17 alone. Upwards opening of the handle 16 alone does not allow the door to be opened because in this case one of the two tongues is still in the closed position. During opening it is necessary to raise both the handles 16-17 outwards or only the handle 17 so that the springs 14′-15′ pass from a rest position into a compressed position, respectively moving also the tongues 14-15 so that they disengage simultaneously the openings 12′-13′ and 12″-13″. By way of a safety measure against any random or involuntary opening, operation of the handle 16 alone does not allow opening of the door since it frees only the tongue 14. The handle 17 is instead formed so that the locking and safety lug 17′ connected to it, during the opening movement, also operates the handle 16 and correspondingly allows both tongues 14 and 15 to be released.

The arrangement of the parts is such as to allow, during the closing operation, both the tongues 14 and 15 to be engaged simultaneously in the fixed structure of the trolley.

The exploded views in FIGS. 1A to 3B show, respectively, from top and from bottom, the individual components of further embodiments of the double-latch closing/opening device. The housing for the double latch device is formed by a box-like element 13a, 13b with a thickness such that it may be seated inside the recess of the panel of the door onto which it is to be fitted. In the embodiment shown in FIGS. 1B, 2B and 3B, the box-like element 13b has an elongated form and has, formed in it, the eyelets 42′ and 43′, which will be described below. The tongues 14-15 of the closing system shown in FIGS. 6, 7 are in this embodiment replaced by the pairs of tongues or levers 32, 34 and 36, 38 which are operationally connected, by means of respective levers 33 and 37, to two handles 16a-17a by means of springs 14′a and 15′a. The springs 14′a and 15′a are connected to a lock support piece 18a which is inserted inside a compartment 18′a in the door. The lock support piece 18a is suitably shaped to receive said tongues, said springs and said pins and be both closed by the end wall of the male box-like element 13a and be hinged on the handles 16a-17a by means of a pin 45. Of the two handles, the handle 17a is further provided with a safety lug 17′a which allows operation of both levers by operating only the handle 17a. The handles 16a and 17a, which are mounted in the lock tray 13, are fixed on the lock support piece 18a by means of the associated pin 45.

The tongues or levers 32-33-34-36-37-38, the compression springs 31, 35. 39, 14′a and 15′a and the lock strikers 40 and 41 mounted on the vertical profile of the trolley panel also form part of the handle. Typically these parts are made of steel. The levers and the springs are seated inside a suitably shaped compartment 25 which is closed by a plate 30.

Functioning of the double latch closing device is now described. In order to open the door it is necessary to operate both pairs of tongues 32, 34, 36, 38 by means of the simultaneous displacement, towards the outside, of the handles 16a and 17a or the handle 17a alone. The outwards opening of the handle 16a alone does not allow the door to be opened because in this case one of the two tongues is still in the closed position. During opening it is necessary to raise both handles 16a-17a outwards or the handle 17a alone; the latter, being provided with a locking and safety lug 17′a, connected to it, during the opening movement, also causes the operation of the handle 16a. Raising the handles 16a-17a allows the springs 14′a-15′a pass from a rest position into a compressed position, respectively operating also the pairs of tongues 32-34 and 36-38 by means of the levers 33-37 so that they disengage simultaneously the lock strikers 40-41. As mentioned above, by way of a safety measure against any random or involuntary opening, operation of the handle 16a alone does not allow opening of the door since it frees only one of the pairs of tongues 32-34 and 36-38. The handle 17a is instead formed so that the locking and safety lug 17′a connected to it, during the opening movement, also operates the handle 16a and correspondingly allows both pairs of tongues 32-34 and 36-38 to be released.

During operation, the door is closed/opened by means of the pair of tongues 32-34 and 36-38 and the levers 33-37 which engage/disengage into/from the strikers 40 and 41 mounted on the vertical profile of the trolley panel. When the door is closed, the strikers 40 and 41 enter into corresponding eyelets 42 and 43 provided on the door panel and eyelets 42′ and 43′ provided on the lock cover 30 and engage with the tongues 32, 34, 36, 38. In the embodiment shown in FIGS. 1B, 2B and 3B the eyelets 42b and 43b are correspondingly provided also on the box-like element 13b. The levers 33 and 37 are moved by the handles 16a and 17a during opening of the door (when the handles are manually raised) and, during their movement and owing to their characteristic form, they open the levers 32, 34, 36, 38, allowing the strikers 40 and 41 to be released.

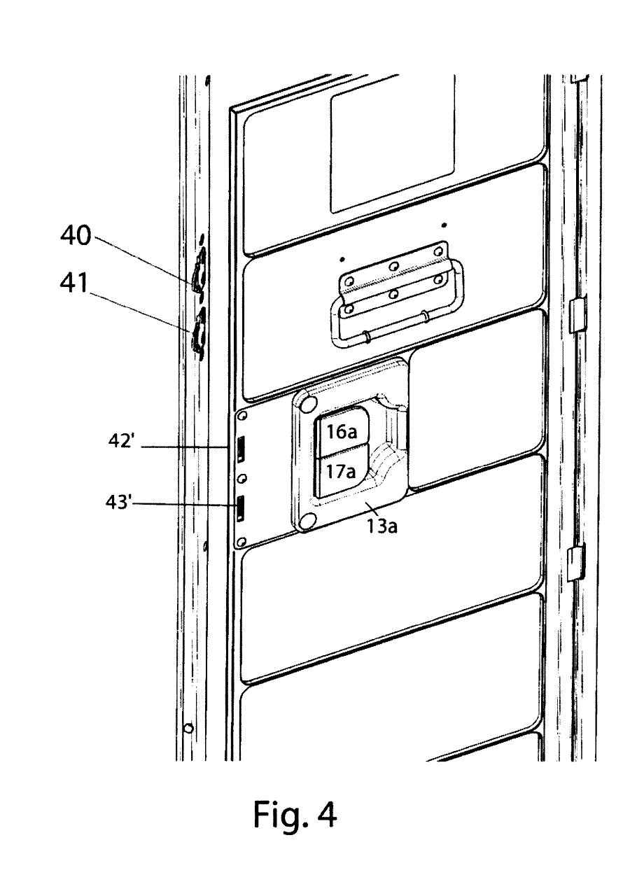

FIG. 4 shows the position of the strikers 40 and 41 on the vertical profiles of the panel and FIG. 5 shows a detail of the strikers which have incisions 44, 44′ on the sides of a projection 46 which in this embodiment terminates in the form of a half-ring, for interlocking engagement of the striker inside the eyelets 42′ and 43′. In turn the incisions 44, 44′ are intended to interlock with the tongues 32, 34, 36, 38.

For operation of the levers, during opening of the door, the handles 16a and 17a must be operated (moving 16a automatically causes movement of 17a), said handles being mounted in the seat 13a and fixed on the lock support piece 18a by means of the associated pin 45. During operation of the handles 16a and 17a the levers 33 and 37 are also moved and, during their movement in the plane of the door, they cause sliding of the pairs of tongues 32-34 and 36-38 with the corresponding release from the incisions 44, 44′ of the lock strikers 40 and 41 and the corresponding opening of the door. The function of the compression springs 31, 35, 39, 14′a and 15′a is to recall the entire mechanism which, in its rest position, is always closed. During closing of the door, instead, no operation is necessary since the simple pressure applied to the door during closing causes the mechanism to work independently without operation of the levers. The plate 30, which is made of plastic or aluminium, merely has the function of covering and protecting the mechanism.

Also in the embodiment shown in FIGS. 1-3, the arrangement of the parts is such that, during the closing operation, both pairs of tongues 32, 34, and 36, 38 are simultaneously engaged in the fixed structure of the trolley, forming a safety device for closing the doors.

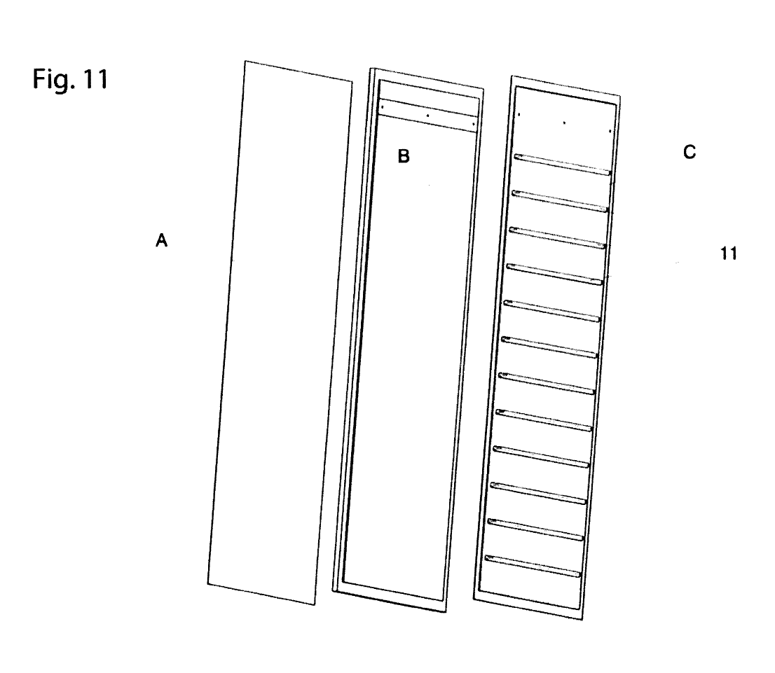

With reference to FIGS. 8-12, these show the ultralight panel and application thereof to a trolley of the aeronautical type. The panel is shown overall in FIG. 11 with its three main component layers: the outer layer or laminate A, the intermediate expanded or honeycomb layer B, and the inner layer or laminate C provided with pressed guides 11.

FIG. 12 is a cross-sectional view of a profile of the inner layer C, showing: the approximate distances between one pressed part and the next one and the associated radii of curvature, where R1, R2 and R3 have respectively the following value: R1=1±0.3 mm, R2=2±0.3 mm R3=3±0.3 mm.

With particular reference to the trolleys, FIGS. 8 to 10 show in schematic form a trolley with a parallelepiped structure having a frame provided with elongated aluminium elements 4 connected in a manner known per se to the corners of the structure and designed to house two side panels, a panel or a rear door (not shown), a front door 5, a top panel 6 and a bottom panel (not shown). All the panels indicated may be provided in accordance with the teachings of the invention; however, the bottom panel is preferably made of metal since this allows easier positioning of the wheels 7 and the brake 8. In the case where the doors are also made of metal, weight-reducing profiles 9 are provided on them using methods known per se. The doors are connected to the structure by means of hinges 10.

The door opening/closing system is shown in the detail of 8A.

The top panel 6 and the side panels 1 are made according to the invention with the layers A, B, C shown in FIG. 11.

FIG. 13 shows in schematic form a device for hot-forming the layer C according to the invention. Said device comprises a metal frame 20 with a quadrangular base which has, horizontally mounted thereon, a die plate 21 for the pressing operation and conveyor rollers 22 for moving the laminate to be pressed C. The punch plate 23 is positioned above and opposite the die plate 21. The combination of the die plate 21 and the punch plate 23 provides the desired pressed form. A hydraulic actuator 24 performs the relative movement of said plates 21 and 23 between which the laminate C is arranged, so as to form the pressed parts 11. The heat source is not shown.

With regard to the above, a preferred embodiment of the invention has been described, without however limiting in any way the invention to the characteristics described. Persons skilled in the art will understand that, in the light of what is disclosed here, modifications and variations may be made without thereby departing from the scope of the present invention as defined by the accompanying claims.

1. A double-latch closing system for closing a shutter on a corresponding frame or upright or portions thereof, said closing system being housed inside a box-like element and comprising a pair of tongues or levers or other closing system of the latch type, the two tongues being operationally connected to respective handles, each of which acts on the corresponding tongue so as to release or engage it from/with the corresponding lock striker, said closing system being characterized in that one of the two handles is provided with locking and safety means designed to move, during the opening movement, the other handle as well and correspondingly release both the tongues, while the operation of one handle only without these locking and safety means does not allow opening of the shutter since it frees only one tongue.

2. The double-latch closing system according to claim 1, wherein the tongues are pairs of levers (32, 34) and (36, 38) which are operationally connected, by means of respective levers (33) and (37), to two handles (16a-17a) by means of springs (14′a and 15′a) which are connected to a lock support piece (18a), the handle (17a) being further provided with a locking and safety means (17′a) which acts on the handle (16); the lock strikers (40) and (41) also form part of the handle and have incisions (44, 44′) on the sides of projections (46) for interlocking engagement of each striker inside eyelets (42′) and (43′) formed on the shutter.

3. The double-latch closing system according to claim 1, which is housed inside a double female/male box-like element, (12), (13), respectively, in which mutually corresponding openings (12′-12″) and (13′-13″) are respectively formed for allowing the entry/exit of the tongues (14-15) for closing/opening the shutter! the tongues (14-15) being operationally connected respectively to two handles (16-17) by means of springs (14′-15′) and pins (14″-15″), the whole assembly being inserted inside a compartment (18) shaped to receive said tongues, springs and pins and be both closed by the end wall of the male box-like element (13) and hinged on the handles (16-17), one of which, the handle (17), being further provided with a lug (17′) which allows both tongues to be operated by operating only one handle (17).

4. A product of manufacture comprising a shutter and a frame which comprise the closing system of claim 1.

5. The product of manufacture of claim 4, selected from the group consisting of: aviation trolleys, ovens, galley inserts, waste compactors, folding trolleys and standard units.

6. A panel comprising a first laminate and a third laminate in which each laminate comprises at least one layer of a composite of glass fibres and kevlar fibres interwoven at an angle of between 45° and 90°, an impregnating polymer resin being provided between said fibres; an intermediate layer is arranged between said first and third laminates, said intermediate layer comprising a material with a density less than or equal to 40 kg/m³ chosen from among closed-cell expanded polymers, polymer foams, and honeycomb materials.

7. The panel according to claim 6, wherein one or more composites of kevlar and glass fibres is/are replaced by a composite of glass fibres interwoven at an angle of between 45° and 90° and impregnated with a polymer resin.

8. The panel according to claim 6, wherein the composite of kevlar and glass fibres and the composite of glass fibres, independently of each other, comprise the fibres in fabric form.

9. The panel according to claim 6, wherein the third layer is provided with pressed parts obtained by thermoforming,
optionally in the form of guides intended to allow the sliding of drawers, shelves, trays and equivalents thereof.

10. The panel according to claim 6, wherein the intermediate layer is reinforced with rigidifying systems such as extruded profiles made of aluminium or other materials which are in any case lightweight with the same or superior mechanical properties.

11. The panel according to claim 6, wherein: the first laminate comprises at least one layer of a composite consisting of kevlar/PEI/glass fibres or kevlar/thermosetting resin/fibres; the intermediate layer comprises a closed-cell expanded polymer; the third laminate comprises at least one layer of a composite consisting of glass fibres/PEI/glass fibres or kevlar/thermosetting resin/fibre or glass-fibre prepreg/PEI or glass-fibre prepreg/thermosetting resin, which are bonded together.

12. A panel-type device comprising at least one panel according to claim 6, selected from the group consisting of aviation trolleys, galley inserts, waste compactors, folding trolleys and standard units.

13. A panel-type trolley comprising panels for side walls, front door, rear door or wall, top and bottom, wherein at least one of said panels is formed with the panels according to claim 6.

14. The panel-type trolley according to claim 13, further provided with a closing system comprising two latches, independent of each other, said system being housed inside a double female/male box-like element, (12), (13), respectively, in which mutually corresponding openings (12′-12″) and (13′-13″) are respectively formed for allowing the entry/exit of the tongues (14-15) for closing/opening the door; the tongues (14-15) being operationally connected respectively to two handles (16-17) by means of springs (14′-15′) and pins (14″-15″), the whole assembly being inserted inside a compartment (18) shaped to receive said tongues, springs and pins and be both closed by the end wall of the male box-like element (13) and hinged on the handles (16-17), one of which, the handle (17), being further provided with a lug (17′) which allows both tongues to be operated by operating only the handle (17).

15. A hot thermoforming device for pressing laminates according to claim 6, comprising a metal frame (20) with a quadrangular base which has, horizontally mounted thereon, a die plate (21) for pressing, conveyor rollers (22) for moving the laminate to be pressed, a punch plate (23) positioned above and opposite the die plate (21), a hydraulic actuator (24) for the relative movement of said plates (21) and (23) between which the laminate is arranged, and a heat source.

16. A method for making a product of manufacture comprising use of a panel according to claim 6,
wherein optionally the product of manufacture is a device used in the aeronautical, automobile, tramway and naval sectors.
